(19) United States
(12) Patent Application Publication
(10) Pub. No.: US 2004/0016127 A1
(43) Pub. Date: Jan. 29, 2004

(54) Impact tool for separating food items frozen together in a stacked array

(76) Inventor: Olan L. Long, Pataskala, OH (US)

Correspondence Address: Francis T. Kremblas, Jr., 7632 Slate Ridge Blvd, Reynoldsburg, OH, 43068, US

(21) Appl. No.: 10/201,469

(22) Filed: Jul. 23, 2002

(51) Int. Cl. B02C 18/00

(52) U.S. Cl. 30/164.6; 30/164.5

(57) ABSTRACT

A kitchen accessory member comprising a tool for separating discrete portions of food items frozen together in a stacked array. The tool includes an impact member having a wedged shaped end forming an edge and a guide rod connected to and extending away from an opposing end of the impact member. A drive member is slideably mounted on the guide rod for manually manipulating the drive member into contact with the impact member or an upper end of the guide rod to force the edge of the wedge-shaped end between adjacent food items in the frozen stacked array of food items to separate adjacent food items from one another.

### (b) CROSS-REFERENCE TO RELATED APPLICATIONS

(Not applicable)

### (c) STATEMENT REGARDING FEDERALLY SPONSORED RESEARCH OR DEVELOPMENT

(Not Applicable)

### (d) REFERENCE TO A “MICROFICHE APPENDIX”

(Not Applicable)

### BACKGROUND OF THE INVENTION

1. Field of Invention

The present invention relates generally to a kitchen type accessory tool and particularly to an impact tool for separating a frozen stack of food items from one another.

2. Background of Related Art

Many persons store individual food items, such as, cut steaks, pork chops and prepared hamburger patties in a stacked relationship to one another in their home freezer. The individual items become frozen together and must be separated from one another prior to being cooked.

In instances where all of the items are to be used at the same time, one may remove the frozen stack from the freezer to permit the items to thaw which renders separation relatively easy. However, this procedure is not practical when fewer than the total number of food items comprising the frozen stack are to be used at a given time.

In such circumstances, the most commonly used procedure involved use of a conventional kitchen knife or the like to pry an individual item from the adjacent item in the frozen stack. Often, this involved trying to pound or jab the blade of the knife between the adjacent edges of the food items. This procedure is often difficult and is always undesireably hazardous and has led to inadvertent injuries to the person trying to separate the items.

Prior to the present invention, those skilled in the art have failed to provide a solution to effectively achieve the desired result in an efficient, user-friendly, and safe manner.

### (f) BRIEF SUMMARY OF THE DISCLOSURE

The impact tool of the present invention comprises an impact member having a pair of opposing major surfaces with one end forming a wedge-shaped edge and a guide rod connected to the impact member extending away from an opposing end in a generally parallel direction to the length of the major surfaces. A driving member is slideably mounted to the guide rod to permit repetitive impacts to be delivered to the opposing end to drive the wedge-shaped end into the seam formed between adjacent items in the frozen stack of items.

As one aspect of the present invention, the impact tool described may be economically manufactured and may comprise metal or plastic components or a combination thereof.

An another aspect of the present invention, the impact tool described is easier to use and is significantly more efficient than prior methods and means.

As a further aspect of the present invention, the impact tool described is less hazardous to use and requires a relatively low degree of strength and manual dexterity to manipulate the tool to accomplish the desired result.

### (g) BRIEF DESCRIPTION OF THE DRAWINGS

FIG. 1 is a perspective view of an impact tool constructed in accordance with the present invention illustrating the drive member aligned above the guide rod which is attached to the impact member;

FIG. 2 is a perspective view of the impact tool shown in FIG. 1 illustrating the impact with drive member slideably mounted on the guide rod in the operative assembled relationship;

FIG. 3 is a top plan view of the drive member shown in FIG. 1 apart from the remaining components;

FIG. 4 is a side elevational view of the drive member shown in FIG. 3;

FIG. 5 is a side elevational view illustrating the guide rod and impact member shown apart from the remaining components shown in FIG. 1;

FIG. 6 is a front elevational view of the impact member and guide rod as shown in FIG. 5;

FIG. 7 is a perspective view of another embodiment of an impact tool constructed in accordance with the present invention illustrating a modified drive member; and

FIG. 8 is a side elevational view partially in section, illustrating the modified drive member of the embodiment shown in FIG. 7, the section being taken along the axis of the bore in the drive member.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### (h) DETAILED DESCRIPTION OF THE INVENTION

The present invention provides a kitchen accessory device in the form of an impact tool for use in separating individual food items frozen in a stacked array. Common items stored in home freezers in such a configuration include pre-cut steaks and port chops, prepared hamburger patties and the like.

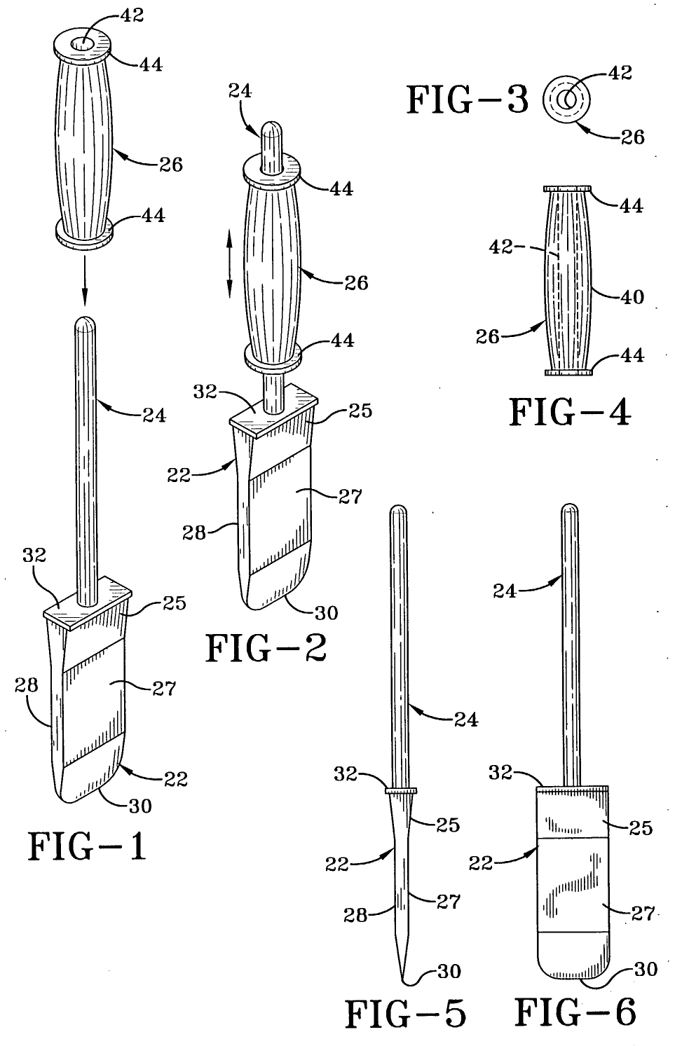

An impact tool, indicated generally at 20, constructed in accordance with the present invention, is shown in FIG. 1. The tool 20 includes an impact member, a guide rod and a drive member, indicated generally at 22, 24 and 26 respectively.

In one preferred embodiment, impact member 22 includes a body 25 having opposing major surfaces 27 and 28 provided with a tapered or wedge shaped end portion forming a thin edge 30. The upper or opposing end 32 of plate 25 may be essentially flat and have substantially a similar thickness as the upper portion of body 25.

While edge 30 is relatively thin, it is not necessary to be formed into a sharpened knife edge similar to a kitchen cutting knife for the purposes of the present invention. Edge 30 is not intended to primarily cut or slice its way through the frozen food items per se, but rather to break the ice forming the bond between adjacent food items and literally wedge itself between the seam formed between adjacent items frozen together. Therefore edge 30 preferably may be described or compared to a relatively dull or blunt knife edge. This tends to reduce the hazard of cutting oneself upon inadvertent contact with edge 30.

The lower end of body 25 adjacent edge 30 may be in the shape shown in FIGS. 1 and 2 wherein the outer portions are rounded off, however a rectangular or other suitable shape would also perform well for purposes of the present invention.

A semicircular shape, an inwardly tapered or the rounded off shape shown in FIG. 1 tends to make initial penetration between the food items more efficient to provide a smaller surface area to initially engage the seam between the adjacent items which gradually widens as edge 30 penetrates further between adjacent food items. Further, the taper of the wedge-shaped end portion in the vertical direction provides for a gradually thicker portion of the impact member to be introduced between the adjacent food items to force the food items apart. However, other suitable shapes may also be used as would be understood by one of ordinary skill to perform the basic function of separating the food items from one another within the context of the present invention.

As shown in FIGS. 1, 4 and 5, guide rod 24 preferably comprises an elongate, rod-like member. In the preferred embodiment shown, body 25 and rod 24 may be molded such that the rod and impact member are integrally formed as a unit. However, they may also be made individually and conventionally attached to one another. In either form, they may comprise any suitable metal or plastic materials.

With specific reference to FIGS. 1, and 2, drive member 26 is slideably mounted on guide rod 24. Drive member 26 may comprise any suitable form which allows the user to adequately grasp drive member 26 and slide it back and forth on guide rod 24 to deliver repetitive force-transmitting engagements to the upper end 32 of impact member 22.

In a preferred embodiment, drive member 26 comprises a metal or metal alloy forming a generally cylindrical main body 40 provided with an axially disposed bore 42 which slideably receives guide rod 24. Member 26 may also be formed from a plastic material, however metal is preferred for durability and greater weight per unit volume. As shown in the FIGS., main body 40 has a rounded slightly curved shape which is wider in the middle section than at the opposing ends for ease and comfort for manually gripping body 40. A lip 44 is provided on each end of main body 40 which tends to protect the hand of the user from inadvertent contact with the upper end 32 upon sliding drive member 30 into contact with upper end 32 of plate 25.

In the embodiment shown, drive member 26 may be mounted upon rod 24 by aligning bore 42 with guide rod 24 and sliding body 40 over the upper end of guide rod 24. Removal of drive member 26 is accomplished by the opposite procedure. The length of guide rod 34 is preferably about 1½ to 3 times greater than the length of drive member 26 to provide a convenient length to slide drive member 26 toward and away from plate 25 to generate sufficient force against plate 25 while conveniently maintaining drive member 38 upon guide rod 24.

If deemed desirable, drive member 26 may be removably retained upon guide rod 24 in any conventional manner, such as for example, via a removable pin or the like extended through a bore provided in an upper portion of guide rod 24 extending above drive member 26, not shown. The removable pin, placed in such a bore after drive member 26 has been mounted on guide rod 24, would act as a stop to limit sliding drive member 26 upwardly beyond the extended upper end of guide rod 24. Of course, removing such a stop pin or the like would permit removal of drive member 26 off the upper end of guide 24 in the same manner as earlier described herein. In an embodiment employing a removable stop or other means limiting the upwardly sliding movement of drive member 26 away from impact member 22, permits the user to maintain the tool in an assembled condition when not in use. This would tend to reduce the risk of inadvertently misplacing the drive member 22 relative to the remainder of the tool during periods of non-use.

To use the embodiment of the impact tool shown in FIGS. 1-6, the user mounts drive member 26 on rod 24 by aligning bore 42 with the upper end of guide rod 24 and slides drive member 26 onto guide rod 24.

Then the user places the edge 30 of impact member 22 against the seam between a pair of adjacent food items in the frozen stack with impact member 22 aligned generally parallel to a plane defined by the surfaces of the food items engaging one another. With one hand the user may hold the stack of food items in the last two or three fingers of one hand with the thumb and forefinger gently holding impact member 22 to maintain alignment of edge 30 with the seam between food items. Preferably, the opposite end of the stack of food items would rest upon a stable surface, such as a kitchen counter or table.

Then, with the other hand, the user grasps drive member 26 and slides it back and forth along guide member 24 to deliver a blow against upper end 32 to drive lower edge 30 into the seam between food items. Depending upon the size of the particular food items, typically 2 to 4 impacts are sufficient to separate one food item from the adjacent item applying a relatively modest amount of force to drive member 26.

Even a series of relatively light taps repeated several times will usually be sufficient to separate one food item from another in the stack. Therefore the impact tool is particularly convenient to use for persons having either strength or some manual dexterity disadvantages. This procedure is repeated until the desired number of food items in a given stack have been separated.

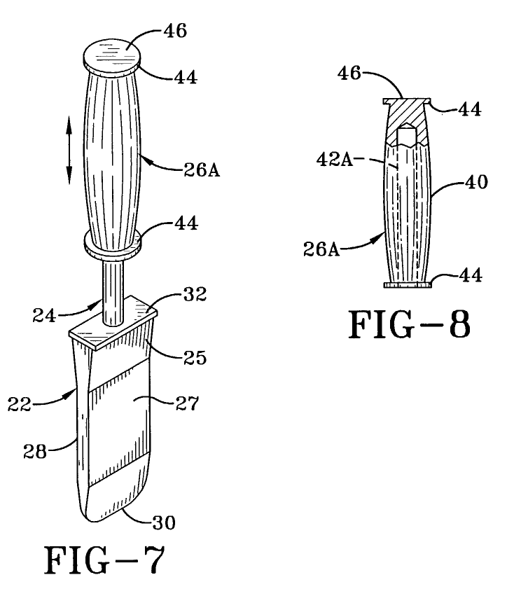

Now referring to another preferred embodiment of the present invention, FIGS. 7 and 8 illustrate a modified drive member 26-A wherein the axially disposed bore 42-A terminates adjacent to a closed upper end 46. With the embodiment illustrated in FIGS. 7 and 8, the length of bore 42-A is selected to limit the downward slidable movement of drive member 26-A on rod 24 such that the lower end of drive member 26-A cannot contact impact member 22. Therefore, upon slideably manipulating drive member 26-A downwardly within bore 42-A, the upper end of rod 24 contacts the closed end of bore 42-A and transmits the force imparted to rod 24 to impact member 22 to accomplish the same function of driving edge 30 of impact member 22 against the seam formed between adjacent food items frozen together as described with respect to the embodiment shown in FIGS. 1-6. Therefore the closed end of bore 42-A functions as a stop or plug within bore 42-A to limit the downward travel of drive member 26-A upon rod 24.

In all other ways the use of the impact tool of the present invention with the modified drive member 26-A is essentially the same as that described herein with respect to the embodiment shown in FIGS. 1-6. The modified drive member 26-A, therefore adds a further safety feature by eliminating any danger to either the hands or fingers of a user from being pinched between the lower end of drive member 26-A and the upper end of impact member 22 upon downward movement of drive member 26-A on rod 24. To assure such an injury cannot occur, the length of rod 24 and bore 42-A are designed to create a sufficient space between the lower end of drive member 26-A and the upper end 32 of impact 22 when the upper end of rod 24 engages the closed upper end of bore 42-A to avoid pinching of the user's hand or finger.

It is believed from the foregoing description that it is understood that the impact tool of the present invention represents a significant improvement over prior methods and means to accomplish the desired results in a safe, efficient, and relatively easy manner to provide a solution to a long unsolved need.

Compared to the prior methods and means, the user may deliver blows to impact member 22 which are automatically accurately aligned with member 22 in the desired direction due to the relationship between member 22, guide rod 24 and drive member 26. Further, the hazard of the user inadvertently striking their hand is virtually eliminated using the present invention.

While certain preferred embodiments of the present invention have been disclosed in detail, it is to be understood that various modifications may be adopted without departing from the spirit of the invention or scope of the following claims.

1. A tool for separating discrete portions of food items frozen together in a stacked array comprising, in combination:
a) an impact member including a pair of opposing major surfaces having a length defined between a first end portion and an opposing wedge shaped second end portion terminating in an edge;
b) an elongate guide rod fixed to said impact member and extending away from said first end portion of said impact member in a direction generally parallel to the length of said major surfaces between said first and second end portions; and
c) a drive member, configured for manual gripping, slideably mounted upon said guide rod for repetitive force-transmitting engagement with one of the first end of said impact member and an upper end of said guide rod to transfer the force of said engagement to said wedge shaped second end.

2. The tool defined in claim 1 wherein said second end portion of the impact member includes a surface area increasing in width in the direction from said edge of said second portion toward said first end portion.

3. The tool defined in claim 1 wherein said edge of said second end portion of said impact member includes a curved configuration.

4. The tool defined in claim 1 wherein said drive member further includes a radially extending lip on an end facing said impact member.

5. The tool defined in claim 1 wherein said drive member includes a central bore having an opening at one end for slideably receiving said guide rod within said bore.

6. The tool defined in claim 6 wherein said central bore includes a stop enageable with the upper end of said guide rod and spaced from said opening to limit the downward movement of said drive member upon said guide rod.
